(19) United States
(12) Patent Application Publication
(10) Pub. No.: US 2008/0295675 A1
(43) Pub. Date: Dec. 4, 2008

(54) LOW FREQUENCY GENERATOR FOR USE BY DRUMMERS

(76) Inventor: Matt Leland, Pineville, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/130,651

(22) Filed: May 30, 2008

Related U.S. Application Data
(60) Provisional application No. 60/941,183, filed on May 31, 2007.

(51) Int. Cl. G10H 3/14

(52) U.S. Cl. 84/730

(57) ABSTRACT

A device (10) used by a drummer to produce low frequency signals in response to the playing of a bass drum (D). Low frequency signals from the device are first amplified and then sent to a subwoofer near the drummer, or tactile transducer connected to the drummer's chair (C). This results in a powerful shaking effect each time the drum is struck. The device is used in a stand alone audio circuit and does not require connection into a band's complete audio system. This is important because it allows the drummer to feel a powerful shaking effect each time the drum is struck when practicing or while playing in situations where an audio system is limited or non-existent.

### CROSS REFERENCE TO RELATED APPLICATIONS

Provisional patent application 60/941,183 filed May 31, 2007.

### STATEMENT REGARDING FEDERALLY SPONSORED RESEARCH OR DEVELOPMENT

N/A

### BACKGROUND OF THE INVENTION

This invention relates to sound generation; and more particularly, to a low frequency sound generator used by drummers or the like, with the sound being amplified and reproduced by a subwoofer or low frequency tactile transducer. The generator is controlled by an input from a transducer located on or near a drum, or by a microphone located on, or in, or near the drum.

It is known to generate a low frequency (10 Hz-250 Hz) sound and supply the amplified signal to a transducer which is, for example, connected to a person's chair or stool. The transducer allows the low frequency signal to be transmitted to the person's body so they experience a physical sensation. See, for example, the ButtKicker® Gamer® at www.thebuttkicker.com. This phenomena is useful both for gaming and also in the playing of music, particularly drum music.

In this latter regard, a drummer, as he plays, wants to experience a powerful shaking effect every time he strikes his bass drum. Currently, drummers have few ways of achieving this effect. The most common method of doing so is to employ a subwoofer which is typically a subsystem of the monitor system. A monitor mix, which is a custom blend of all the microphones setup on and about a stage, is processed by a crossover that typically separates out low frequencies; e.g., those frequencies below 200 Hz. Since the monitor mix comprises a blend of the low frequency sounds produced by all the instruments in the band, the resulting low frequency output contains a blend of all of these low frequency sounds.

While the above described way works, it nevertheless creates many problems. One is that it is prone to feedback through the microphone used with the drummer's bass drum. In general, drummers playing contemporary music require more bass drum signal in their monitor mix. Further, when they are playing, the drummers want to feel a powerful shaking effect from their bass drum. Current monitor systems cannot readily produce this desired effect. As a result, tactile transducers mounted on the drummer's stool (or throne) are increasingly being used instead of subwoofers. However, the transducers (as well as the subwoofers) output the low frequency sounds from many of the microphones used by the band and the resulting sounds are prone to distortions, phase cancellations, and feedback.

### BRIEF SUMMARY OF THE INVENTION

The present invention, referred to commercially as the Digikick™, is a device used in a drummer's setup to create a specific signal for a subwoofer or tactile transducer that results in a powerful shaking effect each time the bass drum of the drum set is struck. The device connects directly to an amplifier and does involve connection into the band's complete audio system. This is important because it allows the drummer to feel the powerful shaking effect each time the bass drum is struck when practicing or while playing in situations where an audio system is limited or non-existent.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a simplified diagram of use of the device of the present invention with a drum;

FIG. 2 is a schematic circuit of a first embodiment of the device; and,

FIG. 3 is a schematic circuit of a second embodiment of the device.

Corresponding reference characters indicate corresponding parts throughout the several views of the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

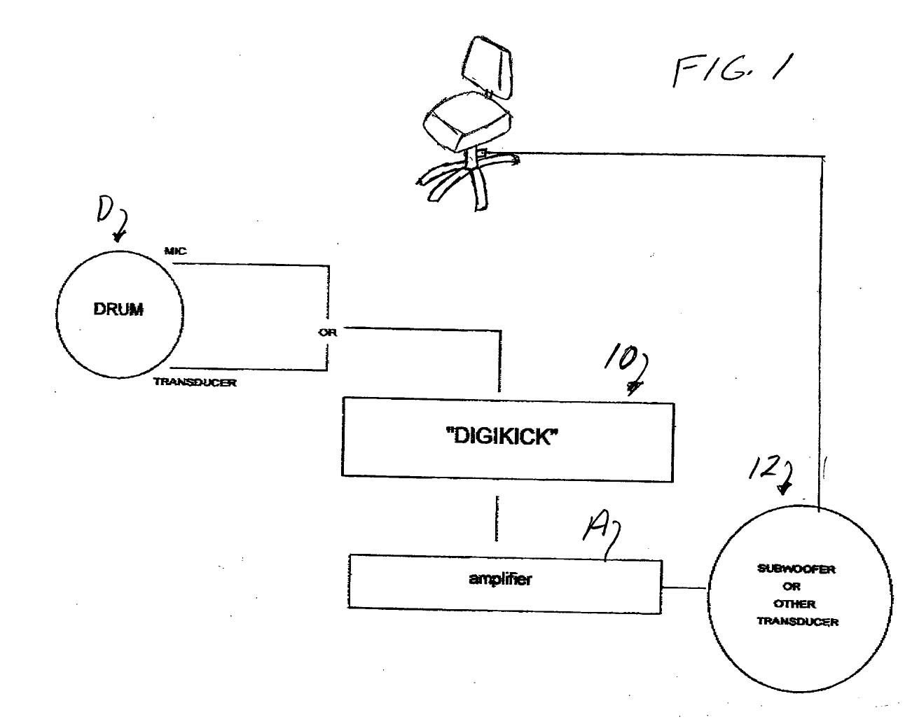

Referring to FIG. 1, device 10 of the present invention is shown used in connection with a drum D such as a bass drum of a drum set. The other pieces comprising the drum set are not shown. An audio frequency sensor such as a microphone MIC or a piezo-type transducer are either attached to, or placed near drum D to pick up any audio vibrations produced when the drum is played. The output from the microphone or the transducer is supplied as an input to device 10.

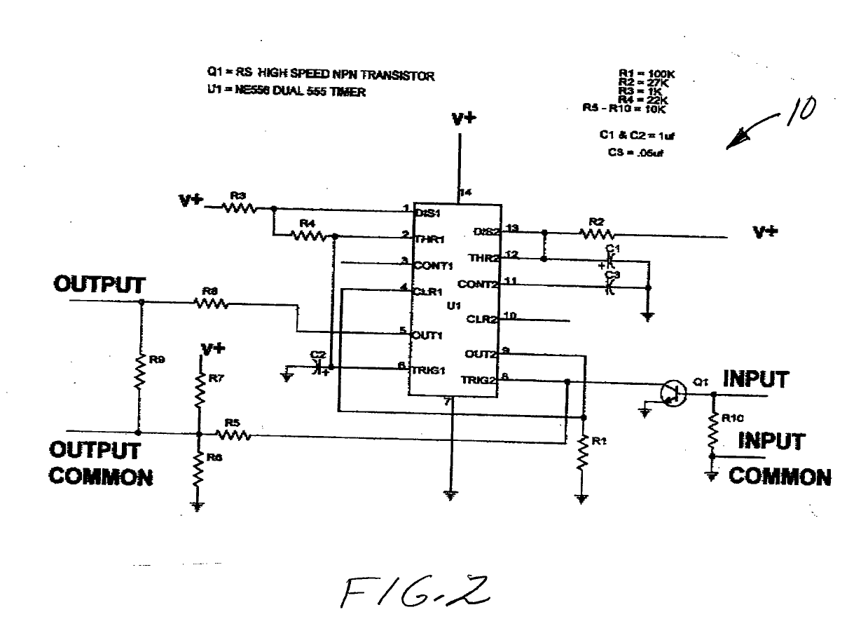

Referring to the schematic of FIG. 2, the output from the audio frequency sensor is applied across the base of a high speed NPN transistor Q1. The collector of the transistor is connected to trigger input (TRIG2) of a timer U1. In response to the characteristics of the input applied to the trigger input of timer U1, a low frequency audio signal; i.e., a specific signal; i.e., a signal having a frequency of less than 200 Hz is produced and supplied as an output from device 10.

The audio frequency signal from device 10 is supplied to an audio amplifier A. The amplified audio frequency signal is then provided as an input to a subwoofer or a tactile transducer 12. As shown in FIG. 1, the transducer is, for example, attached to the frame of a chair C used by the drummer when playing the drums. The vibrations produced by the amplified low frequency signal are now transmitted into the chair causing it to vibrate and give the drummer a powerful shaking effect whenever drum D is struck.

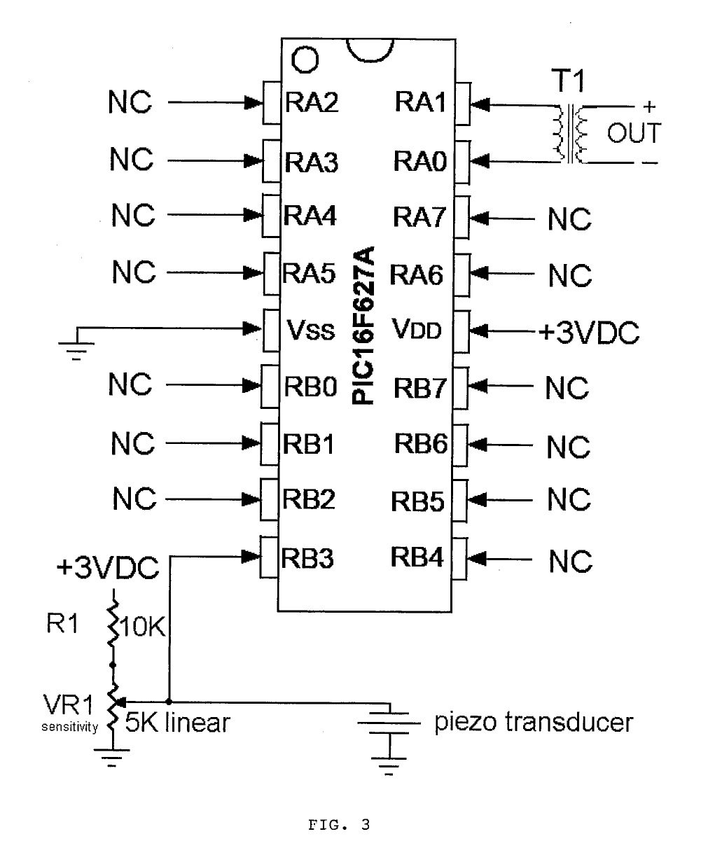

In a second and preferred embodiment of the invention, and with reference to FIG. 3, a microcontroller is used in place of the timer U1. The microcontroller is, for example, a PLC16F627A microcontroller. Now, when a drummer strikes his instrument, the striking of the drum causes a piezo transducer to vibrate. A DC voltage is supplied to an input RB3 of the microcontroller through a voltage divider comprising a fixed resistor R1 and a variable resistor or potentiometer VR1. This voltage divider imposes a bias voltage on input RB3 which is, for example, variable between 0 VDC and +1 VDC. The output from the transducer, as a result of the vibration produced by the drum, imposes an AC ripple on this bias voltage.

Now, when the input voltage supplied to the microcontroller exceeds the threshold voltage imposed on input RB3, a low frequency audio tone is generated by the microcontroller's firmware. This low frequency output is impressed across the primary windings of a transformer T1 which is connected across output ports RA1 and RA1 of the microcontroller. The frequency signal produced across the secondary windings of the transformer signal is now provided as the input to the subwoofer or tactile transducer 12 through audio amplifier A. As previously described, transducer 12 is attached to the frame of the chair C used by the drummer when playing the drums. Again, the vibrations produced by the amplified low frequency signal are transmitted into the chair causing it to vibrate and give the drummer a powerful shaking effect whenever drum D is struck.

Device 10 has several important features.

First, it provides very nearly immediate response to the drummer as he plays his music.

Second, with the setup shown in FIG. 1, there is no feedback which would distort the sensations provided to the drummer, or limit the available amount of effect.

Third, the device is used in a stand alone installation. No complex audio system is required to produce the desired effects for the drummer. This allows the drummer to have better practice sessions and to play in environments where there are no complex audio setups.

Fourth, the device, in conjunction with amplifier A and transducer or subwoofer 12, provides the drummer a powerful shaking effect from their bass drum D. A similar effect is difficult to achieve with current monitor systems.

In view of the above, it will be seen that the several objects and advantages of the present disclosure have been achieved and other advantageous results have been obtained.

Having thus described the invention, what is claimed and desired to be secured by Letters Patent is:

1. A device used by a drummer to produce vibrations sensed by the drummer in response to the drummer playing a drum, comprising:
an audio frequency sensor attached to, or placed near the drum to pick up audio vibrations produced by the drum when it is played and producing an output signal indicative thereof;
means responsive the output signal from the audio frequency sensor to produce a low frequency signal; and,
means adjacent the drummer to which the low frequency signal is supplied for producing a vibration felt by the drummer whenever the drummer strikes the drum.

2. The device of claim 1 in which the means responsive to the output signal from the audio sensor comprises a microcontroller.

3. The device of claim 1 in which the means responsive to the output signal from the audio sensor comprises a timer.

4. The device of claim 1 in which the audio frequency sensor comprises a microphone.

5. The device of claim 1 in which the audio frequency sensor comprises a piezo transducer.

6. The device of claim 1 further including an amplifier amplifying the low frequency signal from the means responsive the output signal from the audio sensor.

7. The device of claim 6 in which the means adjacent the drummer comprises a subwoofer.

8. The device of claim 6 in which the means adjacent the drummer comprises a tactile transducer connected to a piece of furniture contacted by the drummer to produce a vibration felt by the drummer whenever the drummer strikes the drum.

9. The device of claim 1 in which the low frequency signal produced by the means responsive the output signal from the audio frequency sensor having a frequency of less than 200 Hz.
